(19) United States
(12) Patent Application Publication
(10) Pub. No.: US 2022/0072783 A1
(43) Pub. Date: Mar. 10, 2022

(54) 3D PRINTER AND PRINTING SYSTEM

(71) Applicant: RYUJIN LAB, INC., Seongnam-si, Gyeonggi-do (KR)

(72) Inventors: Seong Jin PARK, Seogwipo-si (KR); Hong Joo LEE, Seoul (KR); Kihyung KIM, Jeungpyeong-gun (KR)

(73) Assignee: RYUJIN LAB, INC., Seongnam-si, Gyeonggi-do (KR)

(21) Appl. No.: 17/419,862

(22) PCT Filed: Dec. 30, 2019
(86) PCT No.: PCT/KR2019/018674

§ 371 Date: Jun. 30, 2021

(30) Foreign Application Priority Data
Dec. 31, 2018 (KR) 10-2018-0173291
Dec. 30, 2019 (KR) 10-2019-0177339

(51) Int. Cl. B29C 64/277; B33Y 30/00; B33Y 50/02; B29C 64/393

(52) U.S. Cl. CPC B29C 64/277; B29C 64/393; B33Y 50/02; B33Y 30/00

(57) ABSTRACT

Proposed are a 3D printer and a printing system capable of selectively radiating backlight only onto an area corresponding to a single layer of an output molded object. The 3D printer includes: a resin accommodation part configured to accommodate a photocurable resin; an LCD unit configured to cure the photocurable resin by radiating light corresponding to a tomographic image onto the resin accommodation part; an LED backlight unit configured to provide backlight to the LCD unit in such a manner as to turn on the backlight in a region where the tomographic image is present and turn off the backlight in the remaining region where the tomographic image is not present in conjunction with an image signal from the LCD unit; and a control unit configured to control the light emission area of the LED backlight unit based on the image signal from the LCD unit.

### TECHNICAL FIELD

The embodiments disclosed herein relate to a three-dimensional (3D) printer and a printing system, and more particularly to a 3D printer and a printing system that are capable of selectively radiating backlight only onto an area corresponding to a single layer of an output molded object.

Background Art In general, a 3D printer (a three-dimensional molding machine) is a technology that uses 3D information of an object composed of a digital file, structures (slices) the object into considerably thin layers, and then stacks a material layer by layer based on this information, thereby implementing an actual molded object.

Such 3D printers can be basically classified into a VAT Photopolymerization type and an FDM (FFF) type.

Among these types of technologies, the VAT Photopolymerization-type technology is a technology that performs 3D printing using a photocurable resin that is cured when exposed to light, such as a resin. It is a technology that forms a molded object by curing a resin in a molding target region by radiating light, radiated from a light source that provides light, onto a container containing the resin.

However, a conventional LED/LCD-based optical engine and resin 3D printer have the following problems because the overall area of an LED panel used as a backlight is always turned on:

First, they are inefficient due to the high energy consumption thereof;

Second, there is a limitation to detailed output as a surrounding curing phenomenon occurs due to the leakage of light from the LCD;

Third, when a high-resolution LCD having a smaller aperture ratio than a low-resolution LCD in the same area is used, the lifespan is shortened due to an increase in the fatigue of the LCD attributable to the LED light source, so that there is a limitation to the application of the high-resolution LCD;

Fourth, it is necessary to improve the lifetime of the LED which is always in an ON state and the lifetime of the LCD where light is radiated in an overall area; and

Fifth, when a large-area 3D printer is manufactured, the amount of light must be increased in proportion to the area and accordingly power increases proportionally, so that there is a limitation to the manufacture of the large-area 3D printer.

As a related art, there are a 3D printer and 3D printing method disclosed in Korean Patent Application Publication No. 10-1504419.

The related art described above has a configuration including: a light source; a light adjustment unit configured to adjust an area onto which light transmitted from the light source is radiated; a resin accommodation part configured to receive light passing through the light adjustment unit so that a photocurable resin accommodated therein is cured; a resin movement unit configured to move the cured photocurable resin so that the photocurable resin accommodated in the resin accommodation part is sequentially cured; and a stage configured to increase an area in which light is radiated onto the resin accommodation part by moving the light adjustment unit or the resin accommodation part along the lengthwise and widthwise directions of the resin accommodation part.

However, the related art described above has problems in that energy consumption is high and lifespan is shortened because the light source is always in an ON state.

Therefore, there is a need for a technology for overcoming the above-described problems.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### DISCLOSURE

### Technical Problem

An object of the embodiments disclosed herein is to propose a 3D printer and printing system that turn on LED backlight for an area where a tomographic image for the molding of an output object is present and turn off LED backlight for the remaining area where the tomographic image is not present, thereby significantly improving contrast ratio and significantly reducing power consumption.

### Technical Solution

As a technical solution for accomplishing the above objects, according to an embodiment, there is provided a three-dimensional (3D) printer including: a resin accommodation part configured to accommodate a photocurable resin therein; an LCD unit configured to cure the photocurable resin by radiating light, corresponding to a tomographic image for the molding of an output object, onto the resin accommodation part; an LED backlight unit configured to provide backlight to the LCD unit in such a manner as to turn on the backlight in a region where the tomographic image is present and turn off the backlight in the remaining region where the tomographic image is not present in conjunction with an image signal from the LCD unit; and a control unit configured to control the light emission area of the LED backlight unit based on the image signal from the LCD unit.

Furthermore, the LED backlight unit may include: a backlight substrate having an area corresponding to that of the LCD unit; and a plurality of point light sources arranged on the backlight substrate at predetermined intervals along the lengthwise and widthwise directions thereof, and configured to provide backlight while individually emitting light under the control of the control unit.

Furthermore, the control unit may determine the coordinates of point light sources corresponding to the tomographic image through the image signal from the LCD unit, and may allow the point light sources corresponding to the determined coordinates to emit light.

Furthermore, the control unit may divide the point light sources, disposed on the backlight substrate, into a plurality of unit regions having a predetermined width and length, and may allow the point light sources of unit regions corresponding to the tomographic image to emit light on a per-unit region basis.

Furthermore, the control unit may group point light sources disposed in the center of the backlight substrate, among the point light sources disposed on the backlight substrate, into one central region having a predetermined width and length, may divide point light sources disposed outside the central region into a plurality of outer regions having a predetermined width and length, and may allow the point light sources to emit light.

Furthermore, the control unit may determine the coordinates of point light sources in the central region corresponding to the tomography image, may allow the point light sources corresponding to the determined coordinates to emit light, and may also allow the point light sources of outer regions corresponding to the tomography image to emit light on a per-outer region basis.

Furthermore, the 3D printer may further include at least one additional backlight unit constructed in the same manner as the LED backlight unit, configured to be operated under the control of the control unit, and connected to the LED backlight unit to expand the light emission area of the LED backlight unit.

Furthermore, the 3D printer may further include: a molding plate installed over the resin accommodation part to be selectively lowered and elevated, and configured to be immersed in the photocurable resin while being lowered and to allow parts of the photocurable resin, cured by the light provided through the LCD unit, to be stacked on the bottom surface thereof, thereby forming a 3D molded object; and an elevation member configured to selectively lower and elevate the molding plate.

Moreover, according to an embodiment, there is provided a printing system including the 3D printer, the printing system including: an image processing unit configured to analyze the 3D shape of a molding target object into lateral tomographic images for respective heights, and to sequentially transmit the lateral tomographic images obtained through the analysis to the control unit of the 3D printer; wherein the 3D printer controls the light emission areas of the LCD unit and the LED backlight unit to correspond to the tomographic image while receiving the tomographic images transmitted from the image processing unit through the control unit.

### Advantageous Effects

The 3D printer and the printing system according to any one of the above-described technical solutions have the following effects:

First, power consumption may be minimized by reducing energy consumption attributable to the light source.

Second, light is radiated only onto a tomographic image region, so that contrast ratio (C/R) is improved, with the result that a surrounding curing phenomenon occurring in an unnecessary region is eliminated and thus detailed output is enabled, thereby significantly improving output quality.

Third, light is selectively emitted only in a tomographic image region, so that the lifespans of not only the LEDs, which are a light source, but also the LCDs are improved, thereby enabling stable driving.

Fourth, an increase in LCD fatigue caused by the radiation of light may be avoided, so that the problem in which lifespan is shortened when a high-resolution LCD panel is applied may be overcome.

Fifth, it is not necessary to increase the amounts of light and power in proportion to an area by applying a backlight that selectively emits light only in a necessary region, so that an increase in power consumption attributable to a large area may be avoided, thereby facilitating the manufacture of a large-area 3D printer.

The effects that can be obtained by the embodiments disclosed herein are not limited to the above-described effects, and other effects that have not been described above will be clearly understood by those having ordinary skill in the art, to which the present invention pertains, from the following description.

### DESCRIPTION OF DRAWINGS

FIG. 1 is a block diagram showing the configuration of a 3D printing system including a 3D printer according to an embodiment;

FIG. 2 is a block diagram showing the configuration of an LED backlight unit constituting a part of a 3D printer according to an embodiment;

FIG. 3 is a block diagram showing the configuration of an LED backlight unit according to another embodiment;

FIG. 4 is a block diagram showing the configuration of an LED backlight unit according to still another embodiment; and

FIG. 5 is a block diagram showing the configuration of the additional backlight unit of a 3D printer according to an embodiment.

### MODE FOR INVENTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

The embodiments will be described in detail below with reference to the accompanying drawings.

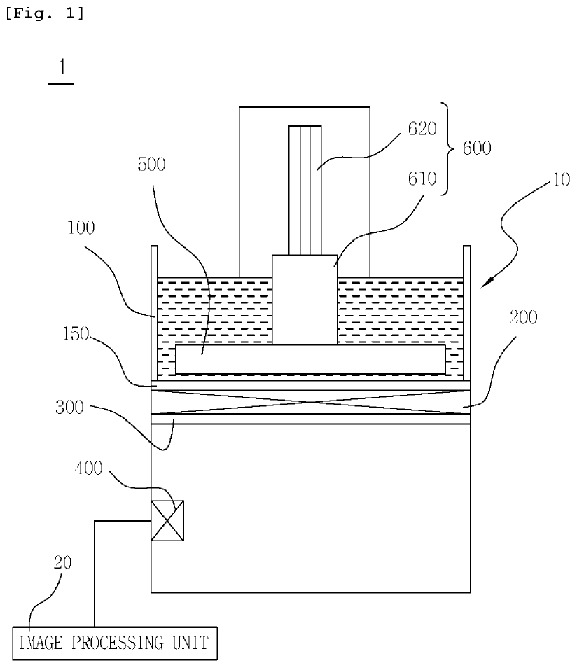

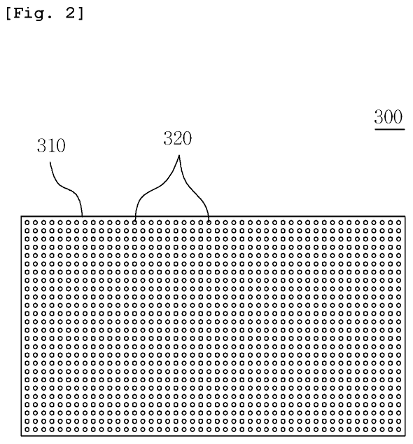

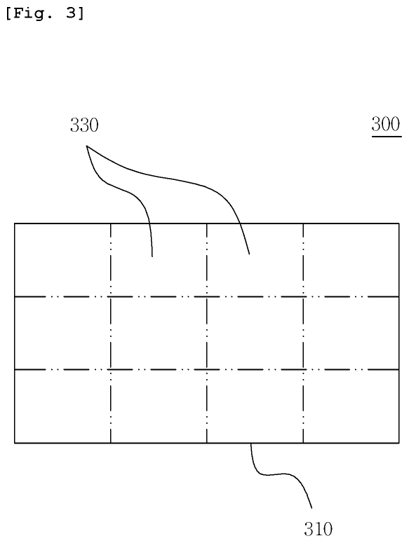

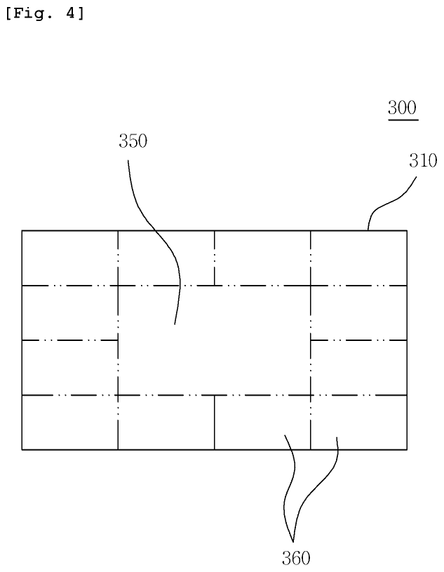

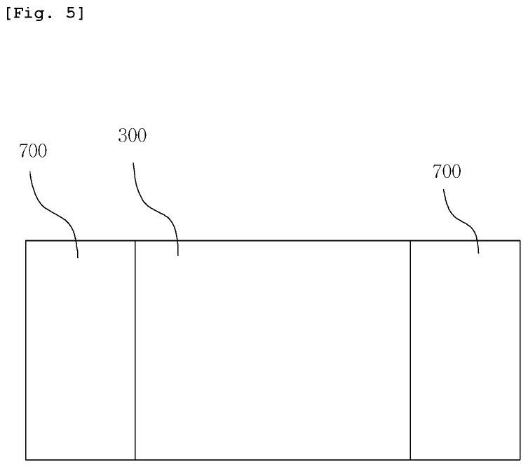

FIG. 1 is a block diagram showing the configuration of a 3D printing system including a 3D printer according to an embodiment, FIG. 2 is a block diagram showing the configuration of an LED backlight unit constituting a part of a 3D printer according to an embodiment, and FIG. 3 is a block diagram showing the configuration of an LED backlight unit according to another embodiment. Furthermore, FIG. 4 is a block diagram showing the configuration of an LED backlight unit according to still another embodiment, and FIG. 5 is a block diagram showing the configuration of the additional backlight unit of a 3D printer according to an embodiment.

Referring to FIG. 1, a 3D printing system 1 according to an embodiment may include a 3D printer 10 and an image processing unit 20, and the 3D printer 10 may include a resin accommodation part 100, an LCD unit 200, an LED backlight unit 300, a control unit 400, a molding plate 500, and an elevation member 600.

The resin accommodation part 100 may be configured in the shape of a container with an open top, and may contain a photocurable resin that is cured by light.

In this case, the photocurable resin is cured upon receiving the light generated by an LCD or the like, and all components known in the art to which the present invention pertains, including a resin, may be applied.

The LCD unit 200 is a component configured to cure the photocurable resin by radiating light, corresponding to a tomographic image for the molding of an output object, onto the resin accommodation part 100.

For example, the LCD unit 200 may cure the photocurable resin in the shape of a tomographic image for molding while radiating light corresponding to the tomographic image onto the resin accommodation part 100 from a location under the resin accommodation part 100.

The LCD unit 200 may cure the photocurable resin in the shape of a tomographic image by switching the light sources of the LED backlight unit 300 to be described later in the shape of the tomographic image and then radiating light onto the resin accommodation part 100.

In this case, when the LCD unit 200 is installed under the resin accommodation part 100, the bottom surface of the resin accommodation part 100 may be formed of a light transmission member 150 and transmit light.

Furthermore, the molding plate 500 to be described later on which the cured photocurable resin can be stacked may be installed to be selectively lowered and elevated, so that parts of the photocurable resin corresponding to tomographic images may be stacked one by one.

In this case, although the LCD unit 200 has been shown as providing light from a location under the resin accommodation part 100, the LCD unit 200 may provide light from a location over or beside the resin accommodation part 100, unlike what is shown in the drawing.

The LED backlight unit 300 is a component installed adjacent to the LCD unit 200 and configured to provide backlight.

In this case, the LED backlight unit 300 may be supported by a support member that is not shown.

The LED backlight unit 300 may provide backlight under the control of the control unit 400 to be described later.

The control unit 400 is a component configured to control the light emission area of the LED backlight unit 300 based on an image signal from the LCD unit 200.

More specifically, the control unit 400 may control the light emission area of the LED backlight unit 300 in conjunction with an image signal applied from the LCD unit 200, and may turn on the backlight of the LED backlight unit 300 in an area corresponding to the tomographic image for molding and turn off the backlight of the LED backlight unit 300 in the remaining area where the tomographic image is not present.

Accordingly, the 3D printer 10 according to an embodiment turns on LED backlight in an area where a tomographic image for the molding of an output object is present, and turns off LED backlight in the remaining area where the tomographic image is not present, thereby significantly improving contrast ratio and reducing power consumption.

The molding plate 500 is a component configured to form a 3D molded object, is installed over the resin accommodation part 100 to be selectively lowered and elevated, is immersed in the photocurable resin while being lowered, and allows parts of the photocurable resin, cured by the light of the above-described LCD unit 200 and LED backlight unit 300, to be stacked on the bottom surface thereof, thereby forming a 3D molded object.

More specifically, the molding plate 500 is selectively lowered and elevated by the elevation member 600 to be described later, and faces the above-described light transmission member 150. In this state, when the light of the LCD unit 200 is radiated, parts of the photocurable resin corresponding to the planar shape of the radiated light may be cured and stacked on the bottom surface of the molding plate 500 and the molding plate 500 may then be elevated back by the elevation member 600.

The elevation member 600 is a component configured to selectively lower and elevate the molding plate 500 over the resin accommodation part 100 under the control of the control unit 400.

The elevation member 600 may include an elevation rail 610 and a slider 620.

The elevation rail 610 may be installed adjacent to the resin accommodation part 100, may extend in a vertical direction, and may provide a lowering/elevating path for the molding plate 500.

The slider 620 is movably coupled to the elevation rail 610 in the state of being fixed to the molding plate 500, and may selectively lower and elevate the molding plate 500 while moving along the elevation rail 610 under the control of the control unit 400.

In this case, the slider 620 and the elevation rail 610 may be constructed in a ball screw structure, a linear motor structure, or a rack and pinion gear structure, and may selectively lower and elevate the molding plate 500 while linearly moving.

Furthermore, the elevation member 600 may include a horizontal movement member (not shown) configured to horizontally move the slider 620 to correct the location of the molding plate 500.

Meanwhile, the LED backlight unit 300 may include a backlight substrate 310 and point light sources 320, as shown in FIG. 2.

The backlight substrate 310 may have an area corresponding to that of the LCD unit 200, and power supply and operation control for the backlight substrate 310 may be performed by the control unit 400 to be described later.

The point light sources 320 are LEDs constituting a light source, and may be configured as a plural of light sources and disposed at predetermined intervals along the lengthwise and widthwise directions of the backlight substrate 310.

These point light sources 320 may individually emit light in a dot form and provide backlight to the LCD unit 200 under the control of the control unit 400.

In this case, the above-described control unit 400 may determine the coordinates of the point light sources 320 corresponding to a tomographic image based on an image signal for the tomographic image applied from the LCD unit 200, and may allow point light sources 320 corresponding to the determined coordinates to individually emit light, thereby enabling backlight corresponding to the tomographic image to be provided.

Alternatively, the control unit 400 may divide the point light sources 320 disposed on the backlight substrate 310 into a plurality of unit regions 330 having a predetermined width and length, as shown in FIG. 3.

In this case, the control unit 400 may determine the coordinates of unit regions 330 corresponding to a tomographic image based on an image signal for the tomographic image, and may allow the point light sources 320 of the unit regions 330 corresponding to the determined coordinates to collectively emit light on a per-unit region basis, thereby enabling backlight to be provided.

In other words, the control unit 400 may allow the point light sources 320 of the unit regions 330 corresponding to the tomographic image to emit light on a per-unit region basis, and may prevent the point light sources 320 of unit regions 330 not corresponding to the tomographic image from emitting light.

In this case, the control unit 400 may easily control the point light sources 320 compared to a configuration in which the point light sources 320 emit light individually.

Meanwhile, the control unit 400 may divide the point light sources 320 into one central region 350 and a plurality of outer regions 360 and control light emission, as shown in FIG. 3.

More specifically, the control unit 400 may group the point light sources 320 disposed in the center of the point light sources 320 disposed on the backlight substrate 310 into one central region 350 having a predetermined width and length, and may divide the point light sources 320 disposed outside the central region 350 into a plurality of outer regions 360 having a predetermined width and length.

In this case, the control unit 400 may individually control the point light sources 320 of the central region 350 to emit light, and may control the point light sources 320 of the outer regions 360 to emit light on a per-region basis.

More specifically, the control unit 400 may determine the coordinates of point light sources 320 of the central region 350 corresponding to a tomographic image and allow the point light sources 320 corresponding to the determined coordinates to emit light, and may determine the coordinates of outer regions 360 corresponding to the tomographic image and allow the point light sources 320 of the outer regions 360 corresponding to the determined coordinates to collectively emit light on a per-region basis, thereby enabling backlight to be provided.

In other words, the control unit 400 may provide light more precisely by allowing the point light sources 320 to individually emit light in the central part where an output object is mainly formed, and may allow the point light sources 320 to collectively emit light on a per-region basis in the outer part in which the output object is formed less.

Meanwhile, the 3D printer 10 according to an embodiment may further include an additional backlight unit 700, as shown in FIG. 5.

The additional backlight unit 700 is a component configured to expand the light emission area of the LED backlight unit 300.

More specifically, the additional backlight unit 700 may be formed of a backlight substrate and a plurality of point light sources in the same manner as the LED backlight unit 300 and emit light under the control of the control unit 400, and may be composed of at least one unit and connected to the LED backlight unit 300, thereby expanding the light emission area of the LED backlight unit 300.

In other words, the additional backlight unit 700 may be connected to the LED backlight unit 300 and applied to a large area 3D printer.

The 3D printer 10 including the above-described components may be applied to the printing system 1 including the image processing unit 20 and perform the printing of an 3D output object, as shown in FIG. 1.

More specifically, the image processing unit 20 may analyze three-dimensional drawings of a molding target object into horizontal tomographic images for respective heights, and may then sequentially transmit the plurality of lateral tomographic images, obtained through the analysis, to the control unit 400 of the 3D printer 10.

In this case, the image processing unit 20 may sequentially transmit the tomographic images from the tomographic image of the upper end of the molding target object in a structure in which the molding plate 500 is elevated from the resin accommodation part 100, and may sequentially transmit the tomographic images from the tomographic image of the lower end of the molding target object in a structure in which the molding plate 500 is lowered into the resin accommodation part 100.

Meanwhile, the image processing unit 20 and the above-described control unit 400 may refer to software or hardware components such as field-programmable gate arrays (FPGAs) or ASICs, but are not limited to software or hardware.

The image processing unit 20 and the control unit 400 may be configured to be in addressable storage media, or may be configured to run one or more processors. Accordingly, as an example, the image processing unit 20 and the control unit 400 include components such as software components, object-oriented software components, class components and task components, and processes, functions, attributes, procedures, subroutines, program code segments, drivers, firmware, microcode, circuits, data, databases, data structures, tables, arrays, and variables.

Furthermore, functions provided in the image processing unit 20 and the control unit 400 may be combined into a smaller number of components or separated from additional components.

In addition, the components, the image processing unit 20, and the control unit 400 may be implemented to run one or more CPUs in a device or security multimedia card.

Meanwhile, the image processing unit 20 and the control unit 400 may be implemented in the form of computer-readable media that store instructions and data executable by a computer. In this case, the instructions and the data may be stored in the form of program code, and may generate predetermined program modules and perform predetermined operations when executed by a processor. Furthermore, the computer-readable media may be any available media that can be accessed by a computer, and includes both volatile and nonvolatile media, and removable and non-removable media. In addition, the computer-readable media may be computer storage media. The computer storage media may include both volatile and nonvolatile media, and removable and non-removable media implemented by any method or technology for the storage of information such as computer-readable instructions, data structures, program modules, or other data. For example, the computer storage media may be magnetic storage media such as HDDs and SSDs, optical storage media such as CDs, DVDs, and Blu-ray disks, or memory included in a server accessible over a network.

Furthermore, the image processing unit 20 and the control unit 400 may be implemented as computer programs (or computer program products) including instructions executable by a computer. The computer programs include programmable machine instructions processed by a processor, and may be implemented in a high-level programming language, an object-oriented programming language, an assembly language, or a machine language. Furthermore, the computer programs may be recorded on tangible computer-readable storage media (e.g., memory, hard disks, magnetic/optical media, solid-state drives (SSDs), or the like).

Accordingly, the image processing unit 20 and the control unit 400 may be implemented in such a manner that computer programs are executed by a computing apparatus, as described above. The computing apparatus may include at least some of a processor, memory, a storage device, a high-speed interface connected to the memory and a high-speed expansion port, and a low-speed interface connected to a low-speed bus and the storage device. These components are connected to each other using various buses, and may be mounted on a common motherboard or in other suitable manners.

In this case, the processor may process instructions within the computing apparatus. Examples of such instructions include instructions stored in the memory or storage device to display graphic information intended to provide a graphic user interface (GUI) onto an external input/output device, such as a display connected to the high-speed interface. As another embodiment, multiple processors and/or multiple buses may be utilized along with multiple pieces of memory and memory forms in an appropriate manner. Furthermore, the processor may be implemented as a chipset composed of chips including a plurality of independent analog and/or digital processors.

Furthermore, the memory stores information within the computing apparatus. As an example, the memory may be composed of volatile memory units or a set of them. As another example, the memory may be composed of non-volatile memory units or a set of them. Furthermore, the memory may be another type of computer-readable medium such as a magnetic or optical disk.

In addition, the storage device may provide large-capacity storage space to the computing apparatus. The storage device may be a computer-readable medium or a component including such a medium. For example, the storage device may include devices within a storage area network (SAN) or other components. The storage device may be a floppy disk device, a hard disk device, an optical disk device, a tape device, flash memory, or another semiconductor memory device or device array similar to flash memory.

The molding plate 500 may be lowered into the resin accommodation part 100 and immersed in the photocurable resin by the operation of the elevation member 600 under the control of the control unit 400.

In addition, the control unit 400 controls the LCD unit 200 to radiate light corresponding to a tomographic image onto the resin accommodation part 100 while controlling the LED backlight unit 300 to provide backlight corresponding to the tomographic image, thereby allowing parts of the photocurable resin to be stacked on the bottom surface of the molding plate 500.

As described above, the 3D printer 10 and the 3D printing system 1 according to the embodiments selectively radiate backlight only onto an area corresponding to a single layer of a molded object, so that power consumption may be reduced, the lifespans of the LED backlight unit 300 and the LCD unit 200 may be improved, and output quality may be improved by preventing a surrounding curing phenomenon occurring in an unnecessary region.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

1. A three-dimensional (3D) printer comprising:
a resin accommodation part configured to accommodate a photocurable resin therein;
an LCD unit configured to cure the photocurable resin by radiating light, corresponding to a tomographic image for molding of an output object, onto the resin accommodation part;
an LED backlight unit configured to provide backlight to the LCD unit in such a manner as to turn on the backlight in a region where the tomographic image is present and turn off the backlight in a remaining region where the tomographic image is not present in conjunction with an image signal from the LCD unit; and
a control unit configured to control a light emission area of the LED backlight unit based on the image signal from the LCD unit.

2. The 3D printer of claim 1, wherein the LED backlight unit comprises:
a backlight substrate having an area corresponding to that of the LCD unit; and
a plurality of point light sources arranged on the backlight substrate at predetermined intervals along lengthwise and widthwise directions thereof, and configured to provide backlight while individually emitting light under a control of the control unit.

3. The 3D printer of claim 2, wherein the control unit determines coordinates of point light sources corresponding to the tomographic image through the image signal from the LCD unit, and allows the point light sources corresponding to the determined coordinates to emit light.

4. The 3D printer of claim 2, wherein the control unit divides the point light sources, disposed on the backlight substrate, into a plurality of unit regions having a predetermined width and length, and allows point light sources of unit regions corresponding to the tomographic image to emit light on a per-unit region basis.

5. The 3D printer of claim 2, wherein the control unit groups point light sources disposed in a center of the backlight substrate, among the point light sources disposed on the backlight substrate, into one central region having a predetermined width and length, divides point light sources disposed outside the central region into a plurality of outer regions having a predetermined width and length, and allows the point light sources to emit light.

6. The 3D printer of claim 5, wherein the control unit determines coordinates of point light sources in the central region corresponding to the tomography image, allows the point light sources corresponding to the determined coordinates to emit light, and also allows point light sources of outer regions corresponding to the tomography image to emit light on a per-outer region basis.

7. The 3D printer of claim 1, further comprising at least one additional backlight unit constructed in a same manner as the LED backlight unit, configured to be operated under a control of the control unit, and connected to the LED backlight unit to expand the light emission area of the LED backlight unit.

8. The 3D printer of claim 1, further comprising:
a molding plate installed over the resin accommodation part to be selectively lowered and elevated, and configured to be immersed in the photocurable resin while being lowered and to allow parts of the photocurable resin, cured by the light provided through the LCD unit, to be stacked on a bottom surface thereof, thereby forming a 3D molded object; and
an elevation member configured to selectively lower and elevate the molding plate.

9. A printing system including the three-dimensional (3D) printer according to claim 1, the printing system comprising:
an image processing unit configured to analyze a 3D shape of a molding target object into lateral tomographic images for respective heights, and to sequentially transmit the lateral tomographic images obtained through the analysis to the control unit of the 3D printer;
wherein the 3D printer controls light emission areas of the LCD unit and the LED backlight unit to correspond to the tomographic image while receiving the tomographic images transmitted from the image processing unit through the control unit.
